(19) United States
(12) Patent Application Publication
(10) Pub. No.: US 2026/0118864 A1
(43) Pub. Date: Apr. 30, 2026

(54) FULL CYCLE DISTRIBUTED MONITORING AND EARLY WARNING METHOD AND SYSTEM FOR FOUNDATION PIT STRUCTURE

(71) Applicant: TONGJI UNIVERSITY, SHANGHAI (CN)

(72) Inventors: BIN HE, SHANGHAI (CN); GANG LI, SHANGHAI (CN); MENG ZHANG, SHANGHAI (CN); PING LU, SHANGHAI (CN)

(21) Appl. No.: 19/009,013

(22) Filed: Jan. 3, 2025

(30) Foreign Application Priority Data
Jan. 5, 2024 (CN) 202410016733.8

(51) Int. Cl. G05B 23/02; H04L 67/125

(52) U.S. Cl. CPC G05B 23/0235; G05B 23/0272; H04L 67/125

(57) ABSTRACT

The present invention discloses a full cycle distributed monitoring and early warning method for a foundation pit structure, comprising: after the construction of a foundation pit is completed, building a distributed data sensor network of the foundation pit structure to collect real-time data of the foundation pit structure; installing sensor communication modules at all sensor installation points in the data sensor network of the foundation pit structure, and establishing a sensor communication transmission mechanism; analyzing and processing the real-time data of the foundation pit structure by an integrated computing service unit to obtain classification monitoring and overall monitoring results of the foundation pit structure, and issuing corresponding early warning information.

### TECHNICAL FIELD

The present invention relates to the technical field of foundation pit structure monitoring, and more particularly relates to a full cycle distributed monitoring and early warning method and system for a foundation pit structure.

### BACKGROUND

Nowadays, as a foundation and preliminary construction project of a building, a foundation pit is an important guarantee for the stable and safe progress of follow-up construction work. A full cycle refers to a full time period from the completion of the foundation pit to the completion of the building and the use, covering all processes from the completion of the foundation pit to the use and the removal of the building. The main purpose of the full cycle monitoring and early warning for the foundation pit structure is to continuously collect and evaluate the data of the foundation pit structure, and provide timely early warning when the data of the foundation pit is abnormal to eliminate the potential safety hazards involved in the building foundation pit.

In the existing monitoring solution of the foundation pit structure, there is a problem that the sensor layout cannot be better combined with the specific foundation pit structure, a unified monitoring network cannot be formed for collection of different types of monitoring data, and more comprehensive and accurate monitoring data cannot be provided. Meanwhile, a sensor communication transmission mechanism is single. When a sensor fails in communication, the sensor communication fault information cannot be obtained in time, the fault cannot be effectively eliminated, and the reliable transmission of sensor data cannot be guaranteed.

In addition, the state information of the foundation pit structure is obtained by correspondingly processing and analyzing the data of a single type of sensor, which cannot guarantee the monitoring accuracy of the foundation pit structure.

Therefore, how to design a full cycle distributed monitoring and early warning method for the foundation pit structure to better understand the state and the change of the foundation pit structure is an urgent problem for those skilled in the art.

### SUMMARY

In view of this, the present invention provides a full cycle distributed monitoring and early warning method for a foundation pit structure, which can better understand the state and the change of the foundation pit structure, and can issue early warning information in time.

In order to achieve the above purpose, the present invention adopts the following technical solution:

In a first aspect, the present invention provides a full cycle distributed monitoring and early warning method for a foundation pit structure, comprising:
step 1: after the construction of a foundation pit is completed, building a distributed data sensor network of the foundation pit structure to collect real-time data of the foundation pit structure, wherein the distributed data sensor network of the foundation pit structure comprises a groundwater level sensor, a supporting axial force sensor and a deep horizontal displacement sensor;
step 2: installing sensor communication modules at all sensor installation points in the data sensor network of the foundation pit structure, and establishing a sensor communication transmission mechanism, wherein the sensor communication transmission mechanism comprises direct communication and indirect communication;
step 3: based on the grid-like data sensor network of the foundation pit structure and the sensor communication transmission mechanism, analyzing and processing the real-time data of the foundation pit structure by an integrated computing service unit to obtain classification monitoring and overall monitoring results of the foundation pit structure, and issuing corresponding early warning information.

Preferably, in the step 1, building a distributed data sensor network of the foundation pit structure comprises:
arranging data sensors of the foundation pit structure in a grid-like way, locating the data sensors of the foundation pit structure on grid points in a grid, and connecting grid lines along bearing columns and walls of the foundation pit structure, wherein the grid can cover the whole foundation pit structure.

Preferably, in the step 2, establishing a sensor communication transmission mechanism comprises:
direct communication: establishing connection with the integrated computing service unit by all the sensor communication modules and conducting data transmission;
indirect communication: when the communication between the sensor communication module and the integrated computing service unit is blocked, selecting other sensor communication modules of direct communication by the sensor communication module with blocked communication for data transmission, establishing connection with the integrated computing service unit by the sensor communication module of direct communication, and conducting data transmission.

Preferably, in the step 3, analyzing and processing the real-time data of the foundation pit structure by the integrated computing service unit to obtain classification monitoring results of the foundation pit structure comprises:
classifying and summarizing the real-time data of the foundation pit structure by the integrated computing service unit, comprising: data of a groundwater level, deep horizontal displacement and supporting axial force in the foundation pit;
comparing the classified and summarized real-time data of the foundation pit structure with corresponding preset safety standard data of the foundation pit structure respectively; and issuing early warning information when a value of the real-time data of a foundation pit structure reaches or exceeds a warning standard value.

Preferably, the early warning information comprises: a location of a sensor exceeding the warning standard value, a type of data collected by the sensor, a specific numerical amount exceeding the warning value and corresponding adjustment measures.

Preferably, in the step 3, analyzing and processing the real-time data of the foundation pit structure by the integrated computing service unit to obtain overall monitoring results of the foundation pit structure comprises:
obtaining a safety factor of the foundation pit structure according to the data of the groundwater level, the deep horizontal displacement and the supporting axial force in the foundation pit structure, with a calculation formula as follows:

$$K = 100 - \frac{100}{{N}_{s} + {N}_{F} + {N}_{w}} ( {\sum }_{1}^{{N}_{s}} \frac{1}{1 + {e}^{- {r}_{s}}} + {\sum }_{1}^{{N}_{F}} \frac{1}{1 + {e}^{- {r}_{F}}} + {\sum }_{1}^{{N}_{w}} \frac{1}{1 + {e}^{{r}_{w}}} )$$

where N_{S} is the number of the groundwater level sensors; N_{F} is the number of the supporting axial force sensors; N_{W} is the number of the deep horizontal displacement sensors; rₛ is a value of the groundwater level after normalization; r_{F} is a value of the supporting axial force after normalization; and r_{W} is a value of the deep horizontal displacement sensors after normalization;
a formula of groundwater level normalization is:

$${r}_{s} = \frac{3 ( - 100 - 10 s )}{100}$$

where s is the data of the groundwater level sensors at a time;
a formula of supporting axial force normalization is:

$${r}_{F} = \{ \begin{matrix}\frac{- ( 6000 - \vert F \vert )}{2000} , & F ∈ ZL 1 \\ \frac{- 3 ( 10000 - \vert F \vert )}{10000} , & F ∈ ZL 2\end{matrix}$$

where F is the supporting axial force, ZL1 is the data obtained by the measurement of a first envelope, and ZL2 is the data obtained by the measurement of a second envelope;
a formula of deep horizontal displacement normalization is:

$${r}_{w} = \frac{30 - w}{10}$$

where w is the data of the deep horizontal displacement sensors;
based on a preset safety factor grading standard of the building foundation pit, determining a safety factor grade of the building foundation pit and issuing the early warning information.

Preferably, the integrated computing service unit adjusts a sampling time interval of the distributed data sensor network of the foundation pit structure based on a construction stage of the foundation pit structure and a situation that causes the reduction of the stability of the foundation pit structure.

In a second aspect, the present invention provides a full cycle distributed monitoring and early warning system for a foundation pit structure, which is used for realizing the full cycle distributed monitoring and early warning method for the foundation pit structure.

According to the above technical solution, compared with the prior art, the technical solution of the present invention has the following beneficial effects:

The technical solution can provide more comprehensive and accurate data. The communication transmission mechanism of direct communication and indirect communication is adopted, which can ensure the timely transmission and accuracy of sensor data, and reduce the possibility of data transmission delay and data transmission errors. In addition, the obtainment of multiple monitoring results can better understand the state and the change of the foundation pit structure, so as to issue the early warning information in time.

### DESCRIPTION OF DRAWINGS

To more clearly describe the technical solutions in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a flow chart of a full cycle distributed monitoring and early warning method for a foundation pit structure provided by the present invention;

FIG. 2 is a structural diagram of a distributed data sensor network of the foundation pit structure provided by the present invention;

FIG. 3 is a structural diagram of a full cycle distributed monitoring and early warning system for a foundation pit structure provided by the present invention.

### DETAILED DESCRIPTION

The technical solutions in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

### Embodiment 1

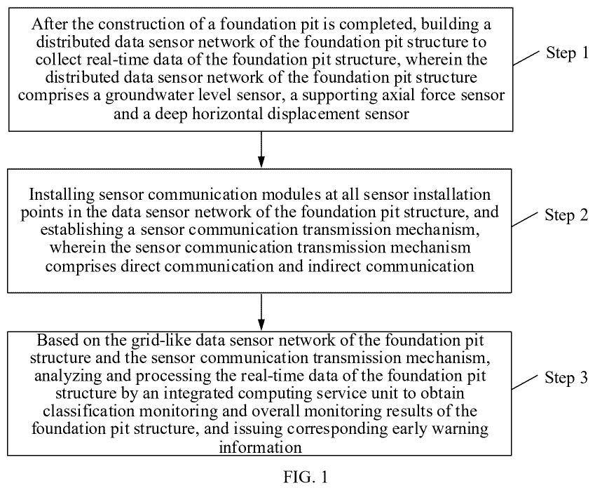

As shown in FIG. 1, the present embodiment provides a full cycle distributed monitoring and early warning method for a foundation pit structure, comprising:
step 1: after the construction of a foundation pit is completed, building a distributed data sensor network of the foundation pit structure to collect real-time data of the foundation pit structure, wherein the distributed data sensor network of the foundation pit structure comprises a groundwater level sensor, a supporting axial force sensor and a deep horizontal displacement sensor;
step 2: installing sensor communication modules at all sensor installation points in the data sensor network of the foundation pit structure, and establishing a sensor communication transmission mechanism, wherein the sensor communication transmission mechanism comprises direct communication and indirect communication;
step 3: based on the grid-like data sensor network of the foundation pit structure and the sensor communication transmission mechanism, analyzing and processing the real-time data of the foundation pit structure by an integrated computing service unit to obtain classification monitoring and overall monitoring results of the foundation pit structure, and issuing corresponding early warning information.

The technical solution can provide more comprehensive and accurate data. The communication transmission mechanism of direct communication and indirect communication is adopted, which can ensure the timely transmission and accuracy of sensor data, and reduce the possibility of data transmission delay and data transmission errors. In addition, the obtainment of multiple monitoring results can better understand the state and the change of the foundation pit structure, so as to issue the early warning information in time.

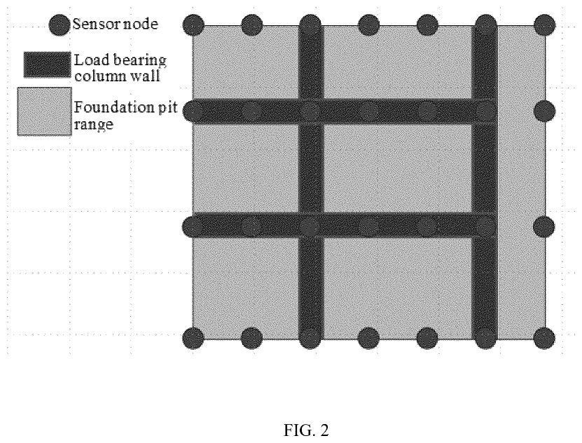

The above steps are further described in detail below:
In the step 1, as shown in FIG. 2, building a distributed data sensor network of the foundation pit structure comprises:
arranging data sensors of the foundation pit structure in a grid-like way, locating the data sensors of the foundation pit structure on grid points in a grid, and connecting grid lines along bearing columns and walls of the foundation pit structure, wherein the grid can cover the whole foundation pit structure.

In the present embodiment, the entire distributed sensor monitoring grid should be slightly larger than the overall building structure, and the length and width dimensions are 110% of the length and width dimensions of the foundation pit building.

In the step 2, establishing a sensor communication transmission mechanism comprises:
direct communication: establishing connection with the integrated computing service unit by all the sensor communication modules and conducting data transmission;
indirect communication: when the communication between the sensor communication module and the integrated computing service unit is blocked, selecting other sensor communication modules of direct communication by the sensor communication module with blocked communication for data transmission, establishing connection with the integrated computing service unit by the sensor communication module of direct communication, and conducting data transmission.

In the present embodiment, an indirect communication method between the sensors and the integrated computing service unit specifically comprises:
denoting the communication overhead of a sensor communication node with blocked communication as 0, denoting the communication overheads with other sensor communication nodes as infinity, and marking all communication nodes as un-accessed;
selecting a sensor communication node with the minimum communication overhead and the closest distance from the sensor communication node with blocked communication from the un-accessed sensor communication nodes as a current node, and marking the current node as accessed;
for all adjacent sensor communication nodes of the current node, calculating the communication overhead from a node with blocked communication at a starting point to the node (the adjacent communication node of the current node), that is, the sum of the communication overhead of the current node from the starting point and the communication overhead between two nodes (the current node and the adjacent sensor communication node thereof); and if the communication overhead is less than the current communication overhead of the node, updating the communication overhead of the node, and then repeating the above steps until all the nodes are accessed or no node can be accessed;
finally, starting from the integrated computing service unit, tracing back to the starting point along the minimum overhead of each node until reaching the starting point, and then establishing connection with the integrated computing service unit by the starting sensor communication node through an optimal path.

In the step 3, analyzing and processing the real-time data of the foundation pit structure by the integrated computing service unit to obtain classification monitoring results of the foundation pit structure comprises:
classifying and summarizing the real-time data of the foundation pit structure by the integrated computing service unit, comprising: data of a groundwater level, deep horizontal displacement and supporting axial force in the foundation pit;
comparing the classified and summarized real-time data of the foundation pit structure with corresponding preset safety standard data of the foundation pit structure respectively; and issuing early warning information when a value of the real-time data of a foundation pit structure reaches or exceeds a warning standard value.

The early warning information comprises: a location of a sensor exceeding the warning standard value, a type of data collected by the sensor, a specific numerical amount exceeding the warning value and corresponding adjustment measures.

Analyzing and processing the real-time data of the foundation pit structure by the integrated computing service unit to obtain overall monitoring results of the foundation pit structure comprises:
obtaining a safety factor of the foundation pit structure according to the data of the groundwater level, the deep horizontal displacement and the supporting axial force in the foundation pit structure, with a calculation formula as follows:

$$K = 100 - \frac{100}{{N}_{s} + {N}_{F} + {N}_{w}} ( {\sum }_{1}^{{N}_{s}} \frac{1}{1 + {e}^{- {r}_{s}}} + {\sum }_{1}^{{N}_{F}} \frac{1}{1 + {e}^{- {r}_{F}}} + {\sum }_{1}^{{N}_{w}} \frac{1}{1 + {e}^{{r}_{w}}} )$$

where N_{S} is the number of the groundwater level sensors; N_{F} is the number of the supporting axial force sensors; N_{W} is the number of the deep horizontal displacement sensors; rₛ is a value of the groundwater level after normalization; r_{F} is a value of the supporting axial force after normalization; and r_{w} is a value of the deep horizontal displacement sensors after normalization;
a formula of groundwater level normalization is:

$${r}_{s} = \frac{3 ( - 100 - 10 s )}{100}$$

where s is the data of the groundwater level sensors at a time;
a formula of supporting axial force normalization is:

$${r}_{F} = \{ \begin{matrix}\frac{- ( 6000 - \vert F \vert )}{2000} , & F ∈ ZL 1 \\ \frac{- 3 ( 10000 - \vert F \vert )}{10000} , & F ∈ ZL 2\end{matrix}$$

where F is the supporting axial force, ZL1 is the data obtained by the measurement of a first envelope, and ZL2 is the data obtained by the measurement of a second envelope;
a formula of deep horizontal displacement normalization is:

$${r}_{w} = \frac{30 - w}{10}$$

where w is the data of the deep horizontal displacement sensors;
based on a preset safety factor grading standard of the building foundation pit, determining a safety factor grade of the building foundation pit and issuing the early warning information.

The integrated computing service unit adjusts a sampling time interval of the distributed data sensor network of the foundation pit structure based on a construction stage of the foundation pit structure and a situation that causes the reduction of the stability of the foundation pit structure.

In the present embodiment, the time interval of data transmission is generally maintained as one transmission per hour during building construction; when the building is completely constructed and put into daily use, the time interval of data transmission is generally maintained as one transmission every three hours; and in the event of natural disasters and other situations that may cause the reduction of the stability of the building in the process of building construction and use, the time interval of data transmission is generally maintained as one transmission every ten minutes.

In addition, after the real-time data of the foundation pit structure is analyzed and processed by the integrated computing service unit to obtain the classification monitoring and overall monitoring results of the foundation pit structure, and the corresponding early warning information is issued, the sampling time interval of the distributed data sensor network of the foundation pit structure is appropriately reduced. The reduction amplitude depends on the degree of exceeding the warning standard. The larger the amplitude of exceeding the warning standard is, the shorter the sampling time cycle of the sensors is.

### Embodiment 2

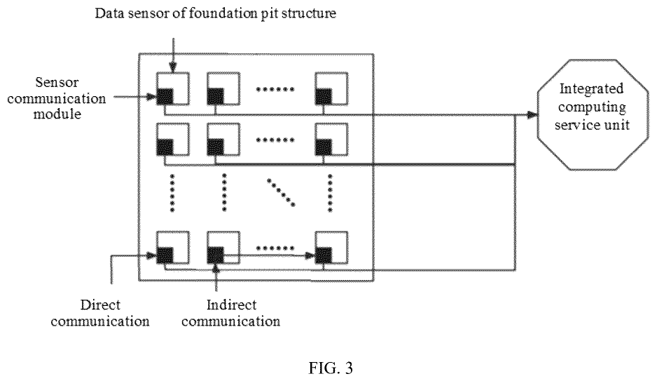

As shown in FIG. 3, the present invention provides a full cycle distributed monitoring and early warning system for a foundation pit structure, which is used for realizing the full cycle distributed monitoring and early warning method for the foundation pit structure and comprises.
data sensors of the foundation pit structure, sensor communication modules and an integrated computing service unit.

The data sensors of the foundation pit structure are used for building a distributed data sensor network of the foundation pit structure to collect real-time data of the foundation pit structure.

The sensor communication modules are used for establishing a sensor communication transmission mechanism, and the sensor communication transmission mechanism comprises direct communication and indirect communication.

The integrated computing service unit is used for analyzing and processing the real-time data of the foundation pit structure to obtain classification monitoring and overall monitoring results of the foundation pit structure, and issuing corresponding early warning information.

Each embodiment in the description is described in a progressive way. The difference of each embodiment from each other is the focus of explanation. The same or similar parts among all of the embodiments can be referred to each other. For a system disclosed by the embodiments, because the system corresponds to a method disclosed by the embodiments, the system is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

What is claimed is:

1. A full cycle distributed monitoring and early warning method for a foundation pit structure, comprising:
step 1: after the construction of a foundation pit is completed, building a distributed data sensor network of the foundation pit structure to collect real-time data of the foundation pit structure, wherein the distributed data sensor network of the foundation pit structure comprises a groundwater level sensor, a supporting axial force sensor and a deep horizontal displacement sensor;
step 2: installing sensor communication modules at all sensor installation points in the data sensor network of the foundation pit structure, and establishing a sensor communication transmission mechanism, wherein the sensor communication transmission mechanism comprises direct communication and indirect communication;
step 3: based on the grid-like data sensor network of the foundation pit structure and the sensor communication transmission mechanism, analyzing and processing the real-time data of the foundation pit structure by an integrated computing service unit to obtain classification monitoring and overall monitoring results of the foundation pit structure, and issuing corresponding early warning information.

2. The full cycle distributed monitoring and early warning method for the foundation pit structure according to claim 1, wherein in the step 1, building a distributed data sensor network of the foundation pit structure comprises:
arranging data sensors of the foundation pit structure in a grid-like way, locating the data sensors of the foundation pit structure on grid points in a grid, and connecting grid lines along bearing columns and walls of the foundation pit structure, wherein the grid can cover the whole foundation pit structure.

3. The full cycle distributed monitoring and early warning method for the foundation pit structure according to claim 1, wherein in the step 2, establishing a sensor communication transmission mechanism comprises:
direct communication: establishing connection with the integrated computing service unit by all the sensor communication modules and conducting data transmission;
indirect communication: when the communication between the sensor communication module and the integrated computing service unit is blocked, selecting other sensor communication modules of direct communication by the sensor communication module with blocked communication for data transmission, establishing connection with the integrated computing service unit by the sensor communication module of direct communication, and conducting data transmission.

4. The full cycle distributed monitoring and early warning method for the foundation pit structure according to claim 1, wherein in the step 3, analyzing and processing the real-time data of the foundation pit structure by the integrated computing service unit to obtain classification monitoring results of the foundation pit structure comprises:
classifying and summarizing the real-time data of the foundation pit structure by the integrated computing service unit, comprising: data of a groundwater level, deep horizontal displacement and supporting axial force in the foundation pit;
comparing the classified and summarized real-time data of the foundation pit structure with corresponding preset safety standard data of the foundation pit structure respectively; and issuing early warning information when a value of the real-time data of a foundation pit structure reaches or exceeds a warning standard value.

5. The full cycle distributed monitoring and early warning method for the foundation pit structure according to claim 4, wherein the early warning information comprises: a location of a sensor exceeding the warning standard value, a type of data collected by the sensor, a specific numerical amount exceeding the warning value and corresponding adjustment measures.

6. The full cycle distributed monitoring and early warning method for the foundation pit structure according to claim 1, wherein in the step 3, analyzing and processing the real-time data of the foundation pit structure by the integrated computing service unit to obtain overall monitoring results of the foundation pit structure comprises:
obtaining a safety factor of the foundation pit structure according to the data of the groundwater level, the deep horizontal displacement and the supporting axial force in the foundation pit structure, with a calculation formula as follows:
$$K = 100 - \frac{100}{{N}_{s} + {N}_{F} + {N}_{w}} ( {\sum }_{1}^{{N}_{s}} \frac{1}{1 + {e}^{- {r}_{s}}} + {\sum }_{1}^{{N}_{F}} \frac{1}{1 + {e}^{- {r}_{F}}} + {\sum }_{1}^{{N}_{w}} \frac{1}{1 + {e}^{{r}_{w}}} )$$
where N_{S} is the number of the groundwater level sensors; N_{F} is the number of the supporting axial force sensors; N_{W} is the number of the deep horizontal displacement sensors; rₛ is a value of the groundwater level after normalization; r_{F} is a value of the supporting axial force after normalization; and r_{w} is a value of the deep horizontal displacement sensors after normalization;
a formula of groundwater level normalization is:
$${r}_{s} = \frac{3 ( - 100 - 10 s )}{100}$$
where s is the data of the groundwater level sensors at a time;
a formula of supporting axial force normalization is:
$${r}_{F} = \{ \begin{matrix}\frac{- ( 6000 - \vert F \vert )}{2000} , & F ∈ ZL 1 \\ \frac{- 3 ( 10000 - \vert F \vert )}{10000} , & F ∈ ZL 2\end{matrix}$$
where F is the supporting axial force, ZL1 is the data obtained by the measurement of a first envelope, and ZL2 is the data obtained by the measurement of a second envelope;
a formula of deep horizontal displacement normalization is:
$${r}_{w} = \frac{30 - w}{10}$$
where w is the data of the deep horizontal displacement sensors;
based on a preset safety factor grading standard of the building foundation pit, determining a safety factor grade of the building foundation pit and issuing the early warning information.

7. The full cycle distributed monitoring and early warning method for the foundation pit structure according to claim 1, wherein the integrated computing service unit adjusts a sampling time interval of the distributed data sensor network of the foundation pit structure based on a construction stage of the foundation pit structure and a situation that causes the reduction of the stability of the foundation pit structure.

8. A full cycle distributed monitoring and early warning system for a foundation pit structure, used for realizing the full cycle distributed monitoring and early warning method for the foundation pit structure according to claim 1.
